(19) United States
(12) Patent Application Publication
(10) Pub. No.: US 2008/0288369 A1
(43) Pub. Date: Nov. 20, 2008

(54) Next Generation Eyewear Retailing

(76) Inventor: Reginald W. Hunter, Round Rock, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/037,606

(22) Filed: Feb. 26, 2008

Related U.S. Application Data
(60) Provisional application No. 60/891,638, filed on Feb. 26, 2007.

(51) Int. Cl. G06Q 30/00; G06Q 50/00

(52) U.S. Cl. 705/27

(57) ABSTRACT

In one embodiment, a method of viewing eyewear products is provided, which includes capturing a digital image of a consumer; standardizing the digital image of the consumer to a set coordinate system, providing a database containing a collection of eyewear images, wherein the images represent actual products for sale, searching the database of eyewear images using criteria input by the consumer, selecting an eyewear image from the search results, superimposing the selected eyewear image onto the digital image of the consumer to give the appearance of the consumer wearing the eyewear, and viewing the image of the eyewear superimposed on the consumer.

### CROSS-REFERENCE TO RELATED APPLICATIONS

This application claims benefit of U.S. provisional patent application Ser. No. 60/891,638, filed Feb. 26, 2007, which is herein incorporated by reference.

### BACKGROUND OF THE INVENTION

1. Field of the Invention

Embodiments of the present invention generally relate to methods for selling and viewing eyewear online. More specifically, embodiments of the present invention relate to processes that allow consumers to view virtual images of eyewear superimposed on virtual representative images of themselves.

2. Description of the Related Art

Approximately 94% of the United States population wears prescriptive eyeglasses. Eyeglasses are replaced many times throughout the life of the user. In response to this need, full service eyewear retail stores have emerged. These full service eyewear stores consolidate eye examinations, frame collections, and the capability to make custom lenses onsite. This “total solution” has facilitated a dramatic reduction in waiting time to acquire new prescriptive eyewear. Lens making tools have also matured. Initially, cut templates for each frame type were used to guide the lens cutting process; now the lens cutting machine can “read” geometry for the lens directly from the frame in most cases.

The weakness in the full services stores is the frame selection process. Retail stores do not have the financial resources, real estate, or manpower to manage a wide selection of frames. Consequently, the consumer must select from a limited array of frames. The selection process is somewhat tedious. The consumer has to scavenge multiple frame candidates that are the correct size and within their price range, and then try them on multiple times in a ranking process where the frames are scattered on a countertop. During the comparison process, the consumer is not wearing corrective lenses, and the frames' plastic lenses are often dirty from handling and in-store display, making it difficult for the consumer to determine which frames looks best. Often during this process the consumer has to rely on input from an acquaintance or the sales clerk.

This process results in a frame selection that the consumer considers to be the “best”. However, it is only the best with respect to the in-store frame selection, and the opinions of the acquaintances and sales clerks present. Furthermore, the customer has difficulty determining additional features about the frame, such as: type of metal, hinges, finish, fabrication method, types of lenses best suited for the frame, etc. All of these additional features may have an influence on frame selection. With few exceptions, the customer knows virtually nothing about the company that made the frame.

For these reasons, it would be desirable to: provide a method of retailing eyewear that minimizes or eliminates frame selection carrying and inventory cost, enabling the price of frames to decrease; provide the consumer with access to a comprehensive international selection of frames; allow the consumer to quickly collect and view frames using various screening preferences; allow frames to be considered by the consumer without having to take their prescription glasses off; allow frames to be considered in a context where they will be worn; allow consumers to share images of themselves with different frames to many acquaintances to solicit their views; establish a data profile of facial geometry allowing more frames to be easily selected during future uses; and to allow customization of the frame to match the consumers' needs.

### SUMMARY OF THE INVENTION

The present invention relates generally to methods for retailing eyewear. In one aspect, the method involves a consumer digitally capturing his or her own image, and then standardizing that image to a specific size. The consumer then uploads the image to an online database containing digital images of eyeglass frames. Additionally or alternatively, the frame images can also be downloaded to the consumer's personal computer. The eyeglass frames can then be superimposed on the image of the consumer to evaluate the aesthetics of each frame selection. The image can be can be modified using graphic software according to consumer preferences. This includes adjustments to the image of the consumer, the quality of the image, and the background of the image. The combined superimposed image will be representative of what the frames will look like while worn by the consumer.

The online database is interactive, and in one embodiment may be a website. The online database can be accessed through the consumers' personal computer, or at a computer kiosk provided at an eyeglass retail store. The database allows users to upload images, search and view supplier products, and store these images. Additionally, the consumer can share these images, and solicit feedback through the database.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart illustrating one embodiment of the present invention;

FIG. 2 is a flow chart illustrating a method of soliciting opinions according to the present invention.

### DETAILED DESCRIPTION

Detailed embodiments of methods of eyewear retailing according to the present invention will be described in the following.

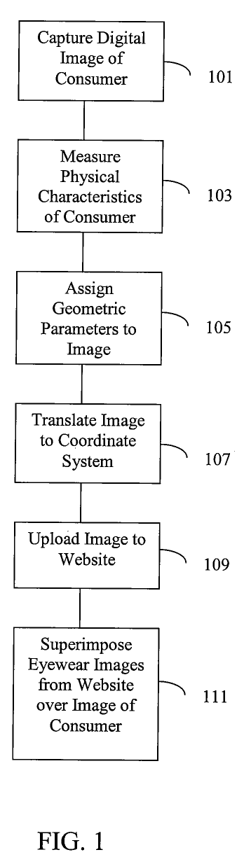

In one embodiment of the invention, as represented by FIG. 1, a consumer captures or provides one or more digital images of his or herself as represented by step 101. The image can be captured using a digital camera, an optical scanner, or by importing an image from another digital application. The consumer can capture images at multiple angles, including front views, side views, and isometric views, for example.

Once the images of the consumer have been captured, a jig, fixture, or apparatus that allows measurements to be accurately and systematically made is employed, represented by step 103. The jig, fixture, or apparatus allows geometric parameters (such as distance between pupils, width of face, distance between ear and bridge of nose, and width of nose at bridge) to be measured. These geometric parameters are then associated with the captured digital image, represented by step 105. For example, one could measure the distance between their pupils using a suitable measuring device, and assign the distance to the digital equivalent of the same measurement. In effect, this would allow precise scaling of the digital image. It is foreseen that the consumer may do as few as one measurement association, but is capable of doing more. Additionally or alternatively, the consumer may take measurements of items in the graphical environment, and assign those measurements to the equivalent located in the digital image during step 105.

Additionally, the capturing of the digital image during step 101 may further include the use of graphic software, or other correction tools to compensate for image distortions. Graphic software capable of image processing and pattern recognition would allow the process to be automated, thereby simplifying the process and ensuring accuracy and quality in the digital images. Also, the software would allow for identification of areas on the image that would be covered by the consumer's hair, and selectively be capable of making these areas transparent, or remove hair from the image. Furthermore, the software may include “blue screen” technology, and allow the consumer to change the background of the image, if the image was captured against an appropriate-colored background.

Following the collection of the images, the images are reprocessed. Reprocessing comprises translating the collected images, represented by step 107, into images which are scaled and calibrated to a standardized coordinate system; for instance, scaling all images to the same pixel size, or scaling the consumer's features (i.e., head size, shape, etc.) to a standard size, and additionally or alternatively, imposing the image onto grid system. The scaling and calibrating of the images as represented by step 107 can be done manually, or can utilize image processing and pattern recognition software to manipulate the images into standardized sizes within a coordinate system. The standardization of the images allows for the images to be properly superimposed with corresponding images of eyewear from a database, as will be discussed in detail later.

During the image reprocessing, the consumer also has the option and ability to input personal criteria to assist in frame selection. The criteria, not limited by example, may include: age, country, type of work, type of recreation, height, weight, hair and eye color, and skin complexion. The personal criteria allows the consumer to narrow the extensive frame collection to only those frames suitable for their needs, and/or in agreement with their aesthetic preferences.

Following the standardization of the digital image, the consumer has the option to further process the image either manually or automatically using software capable of editing or modifying digital images. For instance, using one or more of the captured reference images of the consumer, the consumer is able to adjust image attributes such as color, hue, brightness, contrast black-point, and white-point of the frame selection page to yield a representative image. The consumer will also be capable of flipping the image to represent a mirror-image when being viewed on a monitor; and further, be able to adjust the settings of the monitor itself. Additionally, the consumer can edit transparent image areas, and areas where hair may block the eyeglass frames; or superimpose layers onto the images. Furthermore, the software can also graphically assist the consumer in defining head shape, such as round, oval, or square, to further assistance in the selection of frames.

Once the consumer is satisfied with the representative digital image, the consumer can then upload the image to a website, or download representative images of eyewear to a personal computer, as represented by step 109. The consumer can then begin superimposing selected frame styles onto the image for viewing, as represented by step 111. The digital frame images used in step 111 are provided through an online database or relational data management tool to link the information to the computer workstation utilized by the consumer. For example, this may be a website. The frame images are digitized and provided by the frame suppliers to be compatible with the standardized consumer images at all angles, and will encompass a full range of frame geometries. Being in digital format, the consumer is optionally able to customize the frames for viewing and ordering, based on the options provided by the supplier. Customization options include, but are not limited to: scaling the frames consistent with supplier's product offering, changing color and finish options, and changing compatible ear and nose pieces. Additionally, frame suppliers are capable of providing zoom and rotatable views of the frame selections.

Accompanying the frame images, suppliers can also provide other information pertinent to the consumer. For instance, suppliers are able to define constraints to be considered when selecting frames, such as applicable lens types or frame durability. Suppliers can also provide frame and model history, images of similar models in the supplier line, and celebrity client names who wear the specific frame model being viewed. The suppliers can also suggest other frame styles the consumer might be interested in, based on the characteristics of the models selected by the consumer.

In addition to frame information, the frame suppliers can also present company information. This information may include product warranty information, company overview information, supplier-direct discounts and promotions, and links to compatible products such as customizable cases.

The online database or relational data management tool also provides additional supplier benefits. For instance, the suppliers are able to test new frame concepts, and gauge consumer reaction. Also, the supplier can more accurately target their advertisements by posting the advertisements on the online database.

The consumer is able to search and select frames from the online database using a selection management portion of the database. This is performed via a website. The selection management portion consists of a series of drop-down menus that allow the consumer to select search criteria to assist in narrowing frame selection. Such criteria may include style, color, or designer, among many others. Additionally, consumers can search the frame database by selecting a “generic frame” and lens, and modifying frame attributes such as size, thickness, color, and shape. The database can then be searched to find frames resembling the modified generic frame.

The consumer is then able to superimpose the selected frames onto their digitized image for viewing and evaluation, as represented by step 111. The consumer can view the superimposed frames on each digitally captured image to assess the frames from multiple angles.

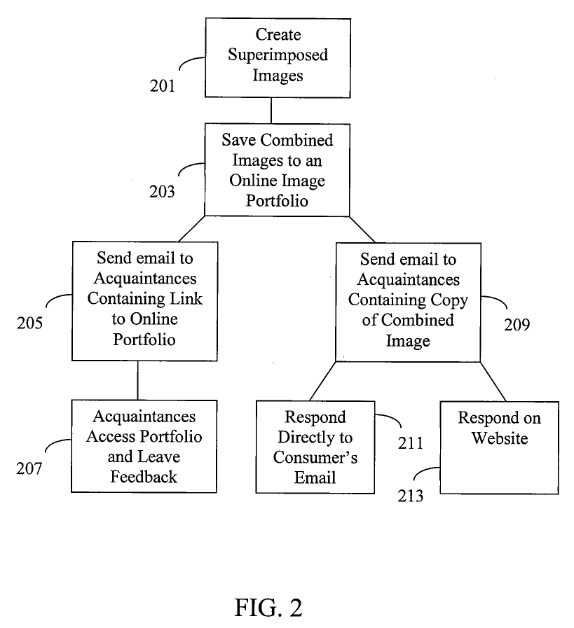

FIG. 2 represents a consumer's options after superimposing the images, as represented by step 201. For instance, the consumer can save each of these superimposed images to a hard disk, or to a password protected online image portfolio, as shown by step 203. When the images are saved to the online image portfolio, the consumer will be able to rank the images in order of preference to help them determine their favorite frame style. The online image portfolio will allow the consumer to change the background of the image via blue screen technology to place the consumer in different visual contexts, such as the beach, mall, or office. Also, the consumer can modify their clothing to match the background context; for instance, swim wear on a beach background. Furthermore, the consumer will have the option to make saved images available to suppliers, which they can use to develop alternative frame styles or use for advertising.

Consumers are able to create PDF and JPG images of themselves in superimposed frames for printing or emailing, such as for use in step 209. For instance, the consumer may want to email images of multiple frames superimposed on the consumer to solicit opinions, as represented by step 209. Opinions can then be directly return emailed to the consumer, as in step 211, or posted on the website, as in step 213. Additionally or alternatively, the online image portfolio can provide a community-access portal where individuals can view certain images saved by the consumer, as represented by step 205. The online image portfolio can facilitate email support, and collect and consolidate responses and opinions, as represented by step 207. Consumers can optionally allow frame suppliers access to the responses and opinions, so that the suppliers can use the information for market research.

Frame suppliers can also to track the amount of consumer views of each product. Furthermore, the suppliers will be able to track the aggregate amount of time consumers spend looking at each product. This information can be used for billing purposes, identification of preferred frames, new product development, and market analysis. Additionally, the online database will provide an interface for consumers to ask questions, and will allow the suppliers to easily collect, consolidate, and answer these questions.

Consumers can make frame selections and place orders directly from the webpage. Shipping and tracking information will be available to the consumer by logging into a password encrypted page. In addition to shipping information, the page can store consumer preferences, images, and past search information.

In one embodiment, the online database, image uploading, image editing, selection management, image portfolio, emailing, and tracking are all encompassed in a single website.

In another embodiment, the online database, image uploading, image editing, selection management, image portfolio, emailing, and tracking are divided among two or more websites.

While the foregoing is directed to embodiments of the present invention, other and further embodiments of the invention may be devised without departing from the basic scope thereof, and the scope thereof is determined by the claims that follow.

What is claimed is:

1. A method of viewing eyewear products, comprising:
providing at least one image of a consumer;
uploading the at least one image of the consumer to a website;
assigning digital parameters to the at least one image of the consumer;
translating the at least one image of the consumer into a standardized coordinate system;
superimposing images of eyewear onto the at least one image of the consumer, wherein the images of the eyewear are available from an online database; and
viewing the image of the eyewear superimposed on the at least one image of the consumer.

2. The method of claim 1, wherein the image of the consumer is in digital format.

3. The method of claim 2, wherein the images of the eyewear have previously been standardized into a coordinate system.

4. The method of claim 1, further comprising modifying the image of the consumer using digital imaging software.

5. The method of claim 1, wherein the online database is accessible through the website.

6. The method of claim 1, wherein the superimposed images of the consumer and the eyewear are saved as one combined image.

7. The method of claim 6, further comprising saving the combined image in a portfolio accessible through the website.

8. The method of claim 6, further comprising soliciting opinions regarding the combined image.

9. The method of claim 1, wherein the online database is searched using criteria input by the consumer.

10. The method of claim 1, further comprising purchasing eyewear from the website.

11. The method of claim 1, wherein multiple images of the consumer are provided, and the multiple images are captured at different angles of viewing the consumer.

12. The method of claim 12, wherein the images of the eyewear are superimposed on the multiple images of the consumer to represent the consumer wearing the eyewear from multiple angles.

13. A method of viewing eyewear products, comprising:
capturing a digital image of a consumer;
standardizing the digital image of the consumer;
providing a database containing a collection of eyewear images, wherein the eyewear images in the database represent products offered for sale;
searching the database of eyewear images using criteria input by the consumer;
selecting an eyewear image from the results of searching the database;
superimposing the selected eyewear image onto the digital image of the consumer; and
viewing the selected image of the eyewear superimposed on the consumer image so as to give the appearance of the consumer wearing the eyewear.

14. The method of claim 13, further comprising measuring physical features of the consumer, and associating the measurements with the digital image of the consumer to provide a scale;

15. The method of claim 13, wherein the standardized digital image is translated onto a coordinate system.

16. The method of claim 13, wherein standardizing the image is automated.

17. The method of claim 13, further comprising purchasing at least one of the represented products.

18. A method of retailing eyewear, comprising:
providing a database of digital images of eyewear representing products for sale, wherein the database is searchable;
selecting a digital image of eyewear from the database;
providing a digital image of a consumer; and
superimposing the digital image of the selected eyewear onto the digital image of the consumer, wherein the combined images represent the consumer wearing the selected eyewear

19. The method of claim 18, further comprising selling the product represented by the digital image of the eyewear.

20. The method of claim 19, wherein the selling of the product represented by the digital image occurs through a website.
